(19) United States
(12) Patent Application Publication
(10) Pub. No.: US 2015/0377817 A1
(43) Pub. Date: Dec. 31, 2015

(54) DETECTOR FOR DETECTING URINE

(71) Applicant: Senno Technology Inc., Hsinchu (TW)

(72) Inventor: Tin-Si Wan, Hsinchu (TW)

(21) Appl. No.: 14/319,355

(22) Filed: Jun. 30, 2014

(51) Int. Cl. G01N 27/30

(52) U.S. Cl. CPC G01N 27/30

(57) ABSTRACT

A detector for detecting urine includes a first electrode, a second electrode and a processing unit. The first electrode and the second electrode are disposed opposite each other, and are soaked in urine under detection. An electrical path is formed among the first electrode, the urine and the second electrode. The processing unit, electrically connected to the first electrode and the second electrode, measures a plurality of ions in the urine transmitted in the electrical path to obtain a conductivity of the urine and to accordingly determine a kidney function status associated with the urine. Compared to a conventional urine test strip, the invention not only provides a precise detection value but also offers advantages of repeatable usage.

### FIELD OF THE INVENTION

The present invention relates to a detector, and particularly to a detector for detecting urine.

### BACKGROUND OF THE INVENTION

Urea and uric acid levels in urine are critical reference indices indicating whether the liver or kidneys in the human body system are functional. Abnormal uric acid levels are a sign of many diseases such as gout and hyperuricemia. Uric acid levels are commonly analyzed by conventional quantitative analysis for organic substances. However, such method has complicated operations and a lengthy analysis period, and requires costly apparatuses. As a result, the detection of uric acid levels with the above conventional method is very inconvenient, and wills of the general public to do the uric acid detection can be significantly lowered. Thus, there is a need for an improved solution.

For example, in the U.S. Pat. No. 6,753,159, an enzyme-based test device for operating in a room temperature is disclosed. The test device includes a dry phase test strip for detecting uric acid concentration in a liquid sample (e.g., urine). A one-step process for detecting the uric acid concentration is also disclosed in the above patent.

However, although such detecting method using the dry phase test strip may be convenient when put to use, the test strip may be inadequate to provide a precise detection value and cannot be repeatedly used. That is to say, the dry phase test strip is a disposable consumable, such that utilization costs are increased when the number of utilization times is increased. Therefore, there is a need for an improved solution.

### SUMMARY OF THE INVENTION

The primary object of the present invention is to solve problems of conventional uric acid test strips that are incapable of providing a precise detection value and cannot be repeatedly used.

To achieve the above object, a detector for detecting urine is provided by the present invention. The detector includes a first electrode, a second electrode, a housing for accommodating the first electrode and the second electrode and a processing unit. The first electrode and the second electrode are disposed opposite each other, and are soaked in urine under detection. An electrical path is formed among the first electrode, the urine and the second electrode. The first electrode includes a first detecting portion, which exposes outside the housing to extend outward. The second electrode includes a second detecting portion, which exposes outside the housing to extend outward. The housing includes a first outer wall disposed at one side of the first detecting portion away from the second detecting portion, a second outer wall disposed at one side of the second detecting portion away from the first detecting portion, and a measurement space formed between the first outer wall and the second outer wall and separating the first detecting portion from the second detecting portion. The first outer wall is formed at a height greater than that of the first detecting portion. The second outer wall is formed at a height greater than that of the second detecting portion. The electrical path is located in the measurement space. The processing unit is electrically connected to the first electrode and the second electrode, and measures a plurality of ions in the urine transmitted in the electrical path to obtain a conductivity of the urine and accordingly determines a kidney function status associated with the urine.

As such, through the first electrode, the second electrode and the processing unit of the present invention, the ions in the urine transmitted in the electrical path are measured, while the conductivity of the urine can be obtain to further determine the kidney function status associated with the urine. The detector of the present invention not only provides a precise detection value, but also offers advantages of reusability, smaller volume and better portability. Further, with the first outer wall, the second outer wall and the measurement space of the present invention, the electrical path in the measurement space is measured, thereby preventing unnecessary disturbances of the urine outside the first outer wall and the second outer wall from affecting the measurement result for the conductivity.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic diagram of an appearance according to an embodiment of the present invention;

FIG. 2 is an exploded view according to the embodiment of the present invention;

FIG. 3 is a partial schematic diagram of a housing according to the embodiment of the present invention;

FIG. 4 is a schematic diagram of an electrical structure according to the embodiment of the present invention; and

FIG. 5 is a schematic diagram of measuring conductivity of urine according to the embodiment of the present invention.

### DETAILED DESCRIPTION OF THE PREFERRED EMBODIMENTS

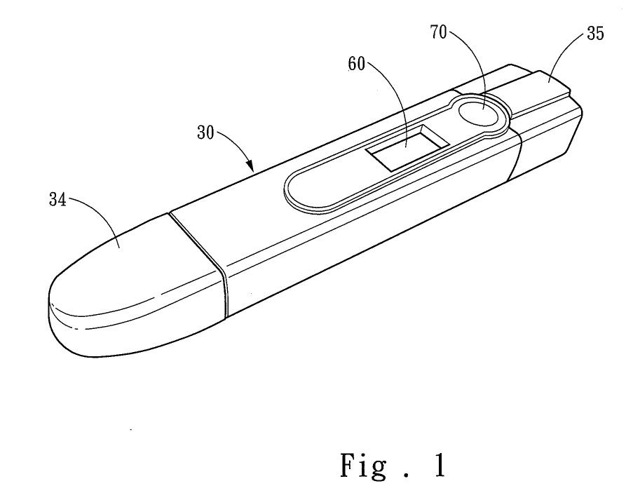

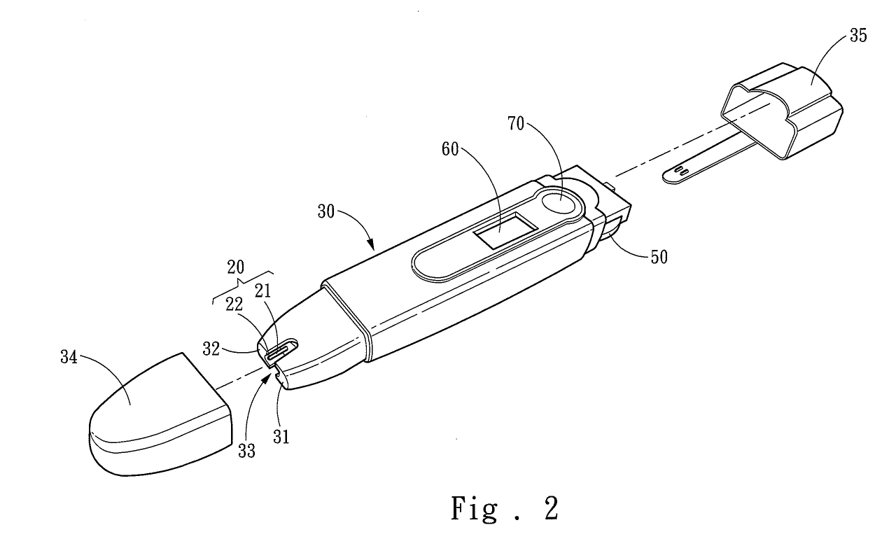

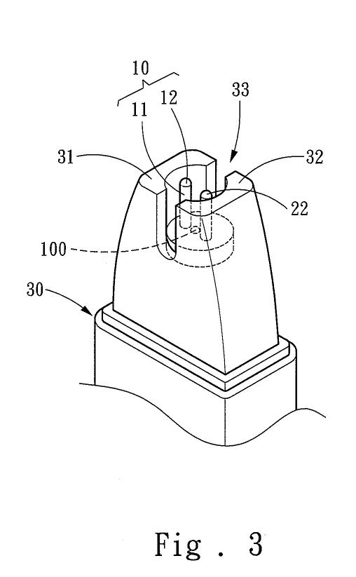

FIG. 1 shows a schematic diagram of an appearance according to an embodiment of the present invention. FIG. 2 shows an exploded view according to the embodiment of the present invention. FIG. 3 shows a partial schematic diagram of a housing according to the embodiment of the present invention. Referring to FIGS. 1, 2 and 3, a detector for detecting urine according to the embodiment of the present invention includes a housing 30, a first electrode 10, and a second electrode 20. The first electrode 10 and the second electrode 20 are disposed in the housing 30 and opposite each other. The first electrode 10 includes a first detecting portion 11 which exposes outside the housing 30 to extend outward and includes a first semicircular end 12. The second electrode 20 includes a second detecting portion 21 which exposes outside the housing 30 to extend outward and includes a second semicircular end 22. In the embodiment, the first detection portion 11 and the second detecting portion 21 are arranged side by side and are spaced from each other by a measurement distance.

The housing 30 includes a first outer wall 31, a second outer wall 32 and a measurement space 33. The first outer wall 31 is disposed at one side of the first detecting portion 11 away from the second detecting portion 21, and is formed at a height greater than that of the first detecting portion 11. The second outer wall 32 is disposed at one side of the second detecting portion 21 away from the first detecting portion 11, and is formed at a height greater than that of the second detecting portion 21. The measurement space 33 is formed between the first outer wall 31 and the second outer wall 32, and further separates the first detecting portion 11 from the second detecting portion 21 to form the measurement distance between the first detecting portion 11 and the second detecting portion 21.

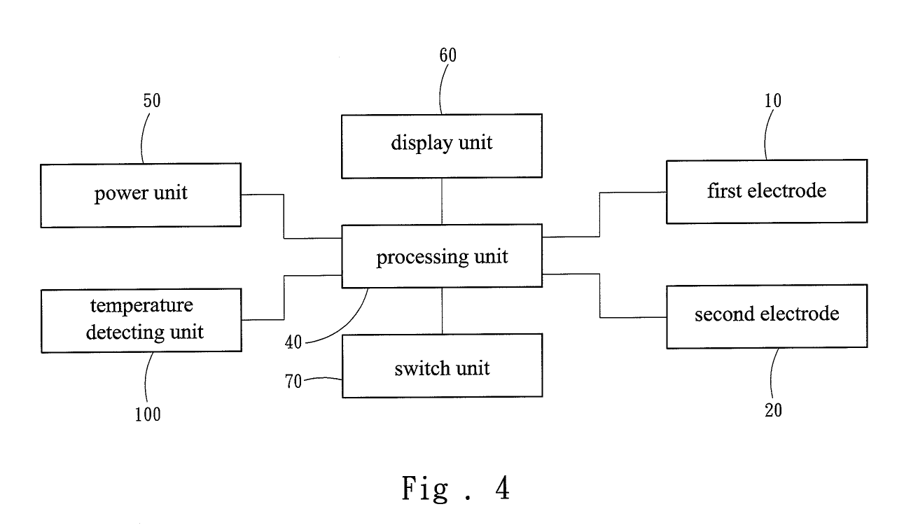

FIG. 4 shows a schematic diagram of an electrical structure according to the embodiment of the present invention. In this embodiment, the detector further includes a processing unit 40, a display unit 60, a power unit 50 and a switch unit 70. The processing unit 40 is disposed in the housing 30, and is electrically connected to the first electrode 10 and the second electrode 20. The display unit 60 is disposed on the housing 30, and is electrically connected to the processing unit 40 for displaying a current condition of the detector, e.g., conductivity of the urine calculated by the processing unit 40. The display unit 60 may be a liquid crystal display (LCD) screen. The power unit 50 may expose outside the housing 30, and is electrically connected to the processing unit 40 to provide the processing unit 40 with an operating power. For example, the power unit 50 is a battery. The switch unit 70 is disposed on the housing 30, and is electrically connected to the processing unit 40 for activating the processing 40 for operations. For example, the switch unit 70 may be an activation button.

In the embodiment, the detector further includes a first cover 34 and a second cover 35. When the first electrode 10 and the second electrode 20 are not performing a measurement procedure, the first cover 34 may cover the first detecting portion 11 and the second detecting portion 21 that expose outside the housing 30 and connect to the housing 30, so as to prevent the first detecting portion 11 and the second detecting portion 21 from exposing to an exterior. The second cover 35 covers the power unit 50 which exposes outside the housing 30 and is connected with the housing 30. When the power unit 50 runs out of power, the second cover 35 may be detached from the housing 30 to replace a new power unit 50. In one embodiment, for example but not limited to, the first cover 34 and the second cover 35 are engaged with the housing 30 by a snapping fastening means.

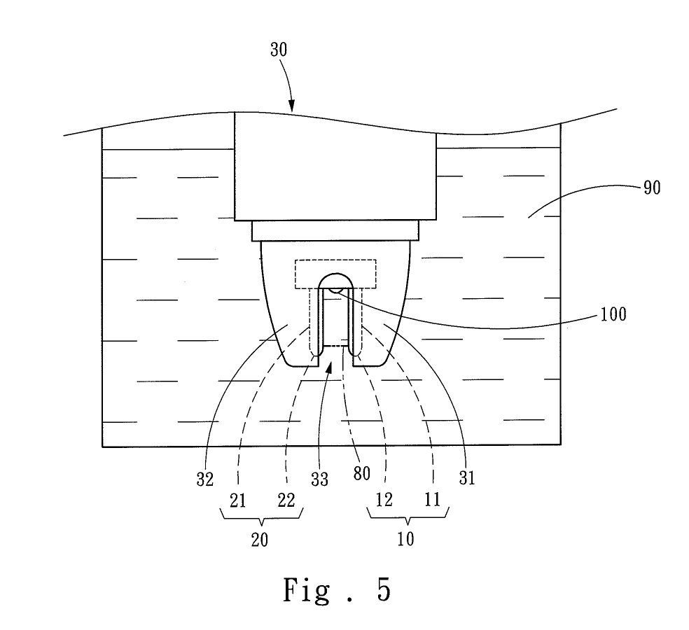

FIG. 5 shows a schematic diagram of measuring conductivity of the urine under detection according to an embodiment of the present invention. In the embodiment, a process for measuring the conductivity of the urine 90 includes the following steps.

First of all, the switch unit 70 is activated to have the power unit 50 supply the operating power for operating the processing unit 40. The detector is then soaked in the urine 90, allowing the first electrode 10 and the second electrode 20 to come into contact with the urine 90. For example, the urine 90 is allowed to enter the measurement space 33, such that the first detecting portion 11 and the second detecting portion 21 both come into contact with the urine 90. As such, the measurement distance between the first detecting portion 11 and the second detecting portion 21 forms an electrical path 80.

Through measuring a plurality of ions in the urine 90 transmitted in the electrical path 80, the processing unit 40 obtains the conductivity of the urine 90. Please refer to the description below regarding the measurement of the conductivity. The urine 90 includes urea, uric acid, protein, glucose, sodium, potassium, chlorine, inorganic phosphorus and calcium. Among the above components, uric acid, sodium, potassium, chlorine, inorganic phosphorus and calcium are electrolytes that exist in form of ions in the urine 90, i.e., the so-called ions of the invention. When the first electrode 10 is electrically connected with the second electrode 20, positive ions in the electrical path 80 migrate to the cathode and negative ions in the electrical path 80 migrate to the anode to respectively generate oxidation reduction reactions.

The overall conductive capability of these electrolytes is referred to the conductivity. The conductivity is represented by L, and is also a reciprocal of the resistance (R). That is:

L=1/R (1)

Like common solid conductors, electrolyte solutions (in the embodiment of the invention, the urine 90) also follow the Ohm's law, and thus equation (1) may be written as:

L=1/R=1/ρ·A/t (2)

In equation (2), ρ is resistance coefficient or specific resistivity, ι is a distance between the electrodes, A is a section area of the conducted solution, and the reciprocal of ρ is referred to as conductivity coefficient, specific conductance or conductivity represented by κ; that is:

κ=1/ρ (3)

Therefore:

L=κ·A/ι (in a unit of S·m⁻¹) (4)

The conductivity of the urine 90 is directly proportional to different kidney functions. More specifically, when the kidney function is normal, a filtration rate of glomeruli in the kidneys is higher, such that the quantity of these electrolytes being filtered to enter the urine 90 is larger Thus, the urine 90 has a higher conductivity. Conversely, when the kidney functions is abnormal, the filtration rate of the glomeruli in the kidneys is lower, such that the quantity of these electrolytes in the urine 90 is smaller, thus causes the urine 90 having a lower conductivity. Therefore, by correlating the conductivity of the urine 90 measured by the processing unit 40 with conductivity data associated with different kidney functions, a kidney function status associated with the urine 90 can be determined.

Further, the conductivity of a liquid usually changes with a variation in temperature. Generally, based on a room temperature of 25° C. as a reference standard, the conductivity rises or drops by 2.1% for every 1° C. rise or drop in temperature. Hence, the detector may further include a temperature detecting unit 100 which is electrically connected to the processing unit 40. In the embodiment, for example, the temperature detecting unit 100 may be thermistor, and exposes in the measurement space 33 to contact with the urine 90, so as to measure the temperature of the urine 90. The processing unit 40 further performs automatic temperature compensation (ATC) procedure to calculate the correct concentration.

It should be noted that, with the first outer wall 31 and the second outer wall 32, a part of disturbances generated by the urine 90 outside the measurement space 33 can be separated to prevent the value of the conductivity from fluctuating drastically. The measurement space 33 allows the urine 90 to flow into the first outer wall 31 and the second outer wall 32 to come into contact with the first detecting portion 11 and the second detecting portion 21.

In conclusion, with the first electrode, the second electrode and the processing unit of the present invention, the ions transmitted in the urine in the electrical path can be measured to obtain the conductivity of the urine to further determine the kidney function status associated with the urine. Thus, comparing with a conventional test strip, the detector of the present invention not only provides a precise detection value, but also has reusability, so as to lower utilization costs that are increased with the number of use in the conventional test strip. Further, comparing with the conventional apparatus for testing urine through quantitative analysis, the detector of the present invention have benefits such as smaller volume and simpler operations that encourage the detection will of the general public to keep awareness on the health. In addition, with the first outer wall, the second outer wall and the measurement space of the present invention, the electrical path in the measurement space is measured, thereby preventing unnecessary disturbances of urine outside the first outer wall and the second outer wall from affecting the measurement result for the conductivity.

What is claimed is:

1. A detector for detecting urine, comprising:
a first electrode, and a second electrode disposed opposite the first electrode, the first electrode and the second electrode being soaked in urine under detection, wherein an electrical path is formed among the first electrode, the urine and the second electrode;
a housing, accommodating the first electrode and the second electrode; the first electrode comprising a first detecting portion exposing outside at the housing to extend outward, and the second electrode comprising a second detecting portion exposing outside at the housing to extend outward; the housing comprising a first outer wall disposed at one side of the first detecting portion away from the second detecting portion, a second outer wall disposed at one side of the second detecting portion away from the first detecting portion, and a measurement space formed between the first outer wall and the second outer wall and separating the first detecting portion from the second detecting portion; the first outer wall being formed at a height greater than that of the first detecting portion, and the second outer wall being formed at a height greater than that of the second detecting portion; the electrical path being located in the measurement space; and
a processing unit, electrically connected to the first electrode and the second electrode, measuring a plurality of ions in the urine to obtain a conductivity of the urine and to accordingly determine a kidney function status associated with the urine.

2. The detector of claim 1, wherein the first detecting portion comprises a first semicircular end, and the second detecting portion comprises a second semicircular end.

3. The detector of claim 2 further comprising a first cover covering the first detecting portion and the second detecting portion and connecting to the housing.

4. The detector of claim 1, wherein the measurement space separates the first outer wall from the second outer wall.

5. The detector of claim 1, further comprising a power unit electrically connected to the processing unit to provide the processing unit with an operating power.

6. The detector of claim 5 further comprising a second cover covering the power unit which exposes outside the housing and connecting to the housing.

7. The detector of claim 1 further comprising a display unit electrically connected to the processing unit, for displaying the detected conductivity of the urine.

8. The detector of claim 7, wherein the display unit is disposed on the housing.

9. The detector of claim 1 further comprising a switch unit electrically connected to the processing unit for activating the processing unit.

10. The detector of claim 1 further comprising a temperature detecting unit electrically connected to the processing unit for detecting a temperature of the urine.
